(19) United States
(12) Patent Application Publication
(10) Pub. No.: US 2026/0008532 A1
(43) Pub. Date: Jan. 8, 2026

(54) BIONIC MULTI-ARMED UNDERWATER UNMANNED VEHICLE FOR UNDERWATER OPERATIONS OF UNMANNED SURFACE VESSEL

(71) Applicant: Shanghai University, Shanghai (CN)

(72) Inventor: Hao WU, Shanghai (CN)

(21) Appl. No.: 19/050,315

(22) Filed: Feb. 11, 2025

(30) Foreign Application Priority Data
Jul. 3, 2024 (CN) 202410887552.2

(51) Int. Cl. B63G 8/42; B25J 11/00; B63G 8/00

(52) U.S. Cl. CPC B63G 8/42; B25J 11/00; B63G 2008/007

(57) ABSTRACT

A bionic multi-armed underwater unmanned vehicle for underwater operations of an unmanned surface vessel is provided. During the process of being towed by the unmanned surface vessel, the underwater unmanned vehicle relies on a crab-like shape design to maintain its own passive stability and balance, seldom relying on active control, and achieves active motion balance based on the balance control of the underwater unmanned vehicle's robotic arms and the propulsion system. This underwater unmanned vehicle can replace underwater operators for underwater operations, is powered and communicates with the unmanned surface vessel through a tow rope, and can also achieve remote control by the operators. It is an underwater unmanned vehicle with the advantages of long-endurance and remote control capabilities, as well as extremely strong underwater operation capabilities.

### CROSS-REFERENCE TO RELATED APPLICATION

This patent application claims the benefit and priority of Chinese Patent Application No. 202410887552.2 filed with the China National Intellectual Property Administration on Jul. 3, 2024, the disclosure of which is incorporated by reference herein in its entirety as part of the present application.

### TECHNICAL FIELD

The present disclosure relates to a bionic multi-armed underwater unmanned vehicle for underwater operations of an unmanned surface vessel.

### BACKGROUND

The current underwater operations for surface vessel mainly rely on manual underwater operations. The disadvantages of this method include high costs, health and safety risks for underwater operators, and low operational efficiency. Additionally, the underwater operators can carry a limited amount and type of tools and equipment, which restricts the types and complexity of the operations they can perform underwater. Moreover, the manual underwater operations are affected by factors such as water currents, water temperature, marine organism, and weather conditions, all of which may lead to interruptions and delays in the operations.

### SUMMARY

To address the issues of the prior art, the present disclosure provides a bionic multi-armed underwater unmanned vehicle for underwater operations of an unmanned surface vessel. It is a novel type of crab-like underwater unmanned vehicle that can replace underwater operators for underwater operations, reducing costs and improving operational efficiency.

The present disclosure may be implemented through the following technical solution.

A bionic multi-armed underwater unmanned vehicle for underwater operations of an unmanned surface vessel is towed by the unmanned surface vessel through a tow rope for realizing communications and power supply, includes a master control module, a buoyancy regulation module, a propulsion module, an underwater unmanned vehicle execution module and a second master control module configured for the underwater unmanned vehicle execution module, and a sensing module, which are located within an underwater unmanned vehicle frame, where the underwater unmanned vehicle frame is connected to an outer frame of the underwater unmanned vehicle via a fixing device. The outer frame of the underwater unmanned vehicle is of a crab-like shape design. When the underwater unmanned vehicle is not required to work, a passive balance of the underwater unmanned vehicle is achieved during towing of the unmanned surface vessel. When there is a work demand for the underwater unmanned vehicle, underwater operators are replaced by the underwater unmanned vehicle to carry out underwater operations. By means of the power supply and communications transmitted by the tow rope of the unmanned surface vessel, power propulsion of the propulsion module, buoyancy regulation of the buoyancy regulation module, and control of the master control module, the underwater unmanned vehicle is capable of achieving an active balance of movement. A sensor module is configured for acquiring underwater images, and the underwater unmanned vehicle execution module comprised of robotic arms is configured for carrying out underwater operations.

Further, the master control module and the sensing module are arranged in a cylindrical watertight compartment which is disposed in a center of the underwater unmanned vehicle frame.

Further, the propulsion module includes eight underwater propellers, and the eight propellers are divided into two configurations, each of the two configurations with four propellers. In one configuration, four propellers are respectively arranged at four corners of an upper part of the underwater unmanned vehicle frame, with a direction perpendicular to a horizontal plane, providing power for the underwater unmanned vehicle to move up and down. In the other configuration, four propellers are respectively arranged at four corners of a lower part of the underwater unmanned vehicle frame, with two propellers arranged in a front and the other two propellers arranged in a rear; an overall direction of the four propellers is parallel to a water surface, and the two propellers in the front are positioned at an angle of 45° relative to each other and the other two propellers in the rear are positioned at the angle of 45° relative to each other, providing power for the underwater unmanned vehicle to move forward, backward, left and right.

Further, the underwater unmanned vehicle execution module includes four robotic arms respectively disposed at the four corners of the upper part of the underwater unmanned vehicle frame.

Further, when the underwater unmanned vehicle is not required to work, the underwater unmanned vehicle, based on a crab-like shape design, reduces a resistance and achieves a passive self-balance during the towing process of the unmanned surface vessel. The four robotic arms are controlled to imitate a movement of limbs of dogs in water to assist the underwater unmanned vehicle to achieve the passive balance during the towing.

Further, the buoyancy regulation module includes two vacuum cylinders respectively disposed on a left of the cylindrical watertight compartment and a right of the cylindrical watertight compartment, with a center axis of each of the two vacuum cylinders parallel to a center axis of the cylindrical watertight compartment.

Further, when there is a work demand for the underwater unmanned vehicle, the buoyancy regulation module regulates buoyancy by increasing or decreasing the air inside the vacuum cylinders, and the master control module controls the eight propellers in the propulsion module according to the current status of the underwater unmanned vehicle, achieving balanced movement in all directions such as up, down, left, right, forward, and backward and thereby meeting the active motion requirements for underwater operations. Additionally, the master control module is capable of controlling the four robotic arms in the underwater unmanned vehicle execution module to imitate the movement of limbs of dogs in water, assisting the underwater unmanned vehicle in active motion, thereby achieving active motion balance during underwater operations.

Further, the fixing device includes eight cylindrical members, each with an inclined plane at one end thereof. The eight cylindrical members are respectively fixed to eight external corners of the underwater unmanned vehicle frame. Eight smooth ends of the eight cylindrical members are respectively connected to the eight external corners of the underwater unmanned vehicle frame by screws, and opposite eight ends of the eight cylindrical members with the inclined plane are connected to the outer frame of the underwater unmanned vehicle by screws, thereby fixing the underwater unmanned vehicle frame within the outer frame of the underwater unmanned vehicle.

Further, the cylindrical watertight compartment and the buoyancy regulation module are respectively connected to the underwater unmanned vehicle frame through fixing connection devices. Each of the fixing connection devices has an upper part with a pan-like shape, and a portion, with a pan-handle-like shape, of the upper part is fixed to the upper part of the underwater unmanned vehicle frame by screw bolts. Each of the fixing connection devices has a lower part which is fastened to the lower part of the underwater unmanned vehicle frame by a tightened steel wire rope.

The present disclosure has the following beneficial effects.

The underwater unmanned vehicle of the present disclosure may achieve passive stabilization with minimal energy loss based on the crab-like shape design, thereby realizing the function of long-endurance; when there is a work demand for underwater operations, operators can remotely control the underwater unmanned vehicle to replace the underwater operators for underwater operations. The propulsion system is relied on to achieve motion balance of the underwater unmanned vehicle and the robotic arms are configured to carry out the required underwater operations. The designed underwater unmanned vehicle is not limited by divers' physical strength and technical skills, and there is no need to consider health and safety risks of underwater operators. Moreover, based on the crab-like design, it can achieve long-endurance, thus reducing the cost of underwater operations. Additionally, the underwater unmanned vehicle's remote control capabilities and powerful underwater operation capabilities can significantly enhance the underwater operation capabilities and efficiencies of the unmanned surface vessel, while also reducing the dependence on weather conditions during operations, improving the reliability and continuity of the operations.

### BRIEF DESCRIPTION OF THE DRAWINGS

FIG. 1 is a right view of an internal structure of an underwater unmanned vehicle according to an embodiment of the present disclosure;

FIG. 2 is a front view of the internal structure of the underwater unmanned vehicle according to an embodiment of the present disclosure;

FIG. 3 is a top view of the internal structure of the underwater unmanned vehicle according to an embodiment of the present disclosure;

FIG. 4 is a right view of an overall structure of the underwater unmanned vehicle according to an embodiment of the present disclosure;

FIG. 5 is a front view of the overall structure of the underwater unmanned vehicle according to an embodiment of the present disclosure;

FIG. 6 is a top view of the overall structure of the underwater unmanned vehicle according to an embodiment of the present disclosure;

FIG. 7 is a schematic diagram of cooperation between an unmanned surface vessel and the underwater unmanned vehicle of the present disclosure.

Reference numerals in the drawings: 1—cylindrical watertight compartment; 2—buoyancy regulation module; 3—propulsion module; 4—underwater unmanned vehicle execution module; 5—fixing connection device; 6—outer frame of the underwater unmanned vehicle; 7—fixing device; 8—underwater unmanned vehicle frame; 9—unmanned surface vessel; 10—tow rope; 11—underwater unmanned vehicle; 12—master control module; 13—sensing module.

### DETAILED DESCRIPTION OF THE EMBODIMENTS

Implementations of the present disclosure are illustrated below by way of specific embodiments, and those skilled in the art would have readily understood other advantages and effects of the present disclosure from the content disclosed in the description.

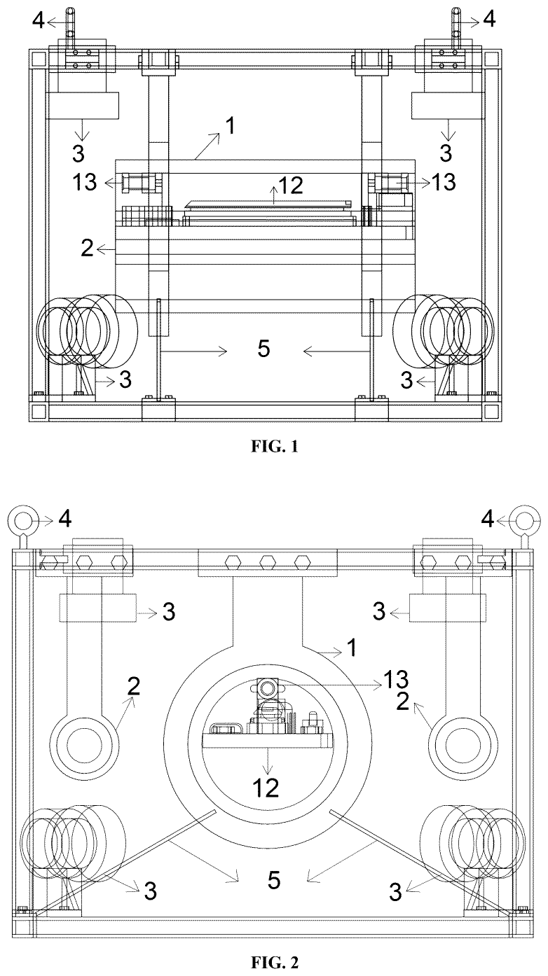

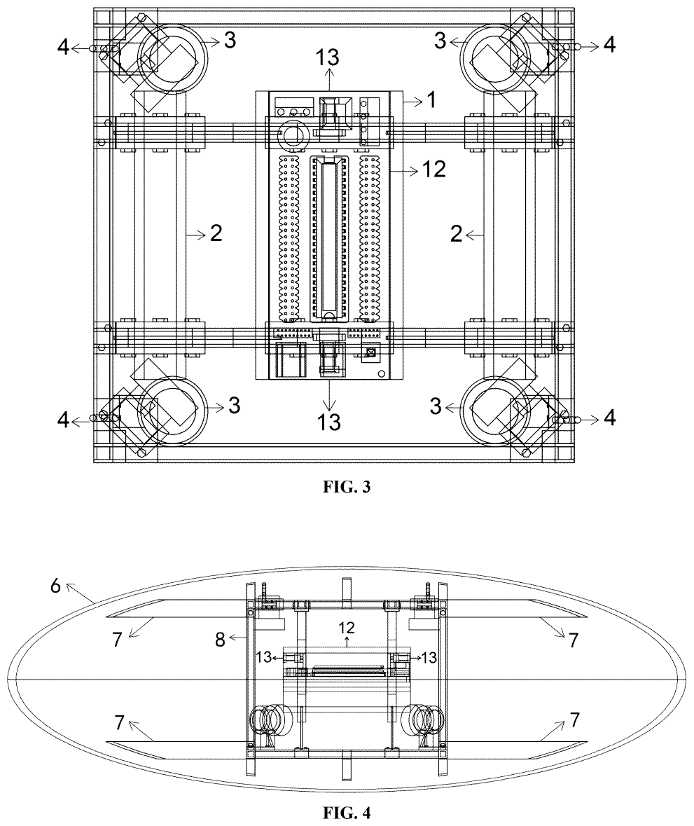

As shown in FIGS. 1, 2 and 3, the underwater unmanned vehicle 11 of the present disclosure has an internal structure including a propulsion module 3, a buoyancy regulation module 2, a sensing module 13 and a master control module 12, which are located within an underwater unmanned vehicle frame 8. The master control module 12 and the sensing module 13 are arranged in a cylindrical watertight compartment 1; the buoyancy regulation module 2 includes two vacuum cylinders for underwater buoyancy regulation. The propulsion module 3 includes eight underwater propellers, and the eight propellers are divided into two configurations, each of the two configurations with four propellers. In one configuration, four propellers are respectively arranged at four corners of an upper part of the underwater unmanned vehicle frame 8, with the direction perpendicular to a horizontal plane, providing power for the underwater unmanned vehicle to move up and down. In the other configuration, four propellers are respectively arranged at four corners of a lower part of the underwater unmanned vehicle frame 8, with two propellers arranged in a front and the other two propellers arranged in a rear; the overall direction of the four propellers is parallel to a water surface, and the two propellers in the front are positioned at the angle of 45° relative to each other and the other two propellers in the rear are positioned at the angle of 45° relative to each other, providing power for the underwater unmanned vehicle 11 to move forward, backward, left and right. An underwater unmanned vehicle execution module denoted with reference numeral 4 includes four robotic arms respectively disposed at the four corners of the upper part of the underwater unmanned vehicle frame 8, and the four robotic arms are configured to carry out underwater operations and assist in movement of the underwater unmanned vehicle 11 in a way of imitating swimming of dogs. The cylindrical watertight compartment 1 and the buoyancy regulation module 2 are connected to the underwater unmanned vehicle frame 8 through fixing connection devices 5. Each of the fixing connection devices 5 has an upper part with a pan-like shape, and a portion, with a pan-handle-like shape, of the upper part is fixed to the upper part of the underwater unmanned vehicle frame 8 by screw bolts. Each of the fixing connection devices 5 has a lower part which is fastened to the lower part of the underwater unmanned vehicle frame 8 with a tightened steel wire rope.

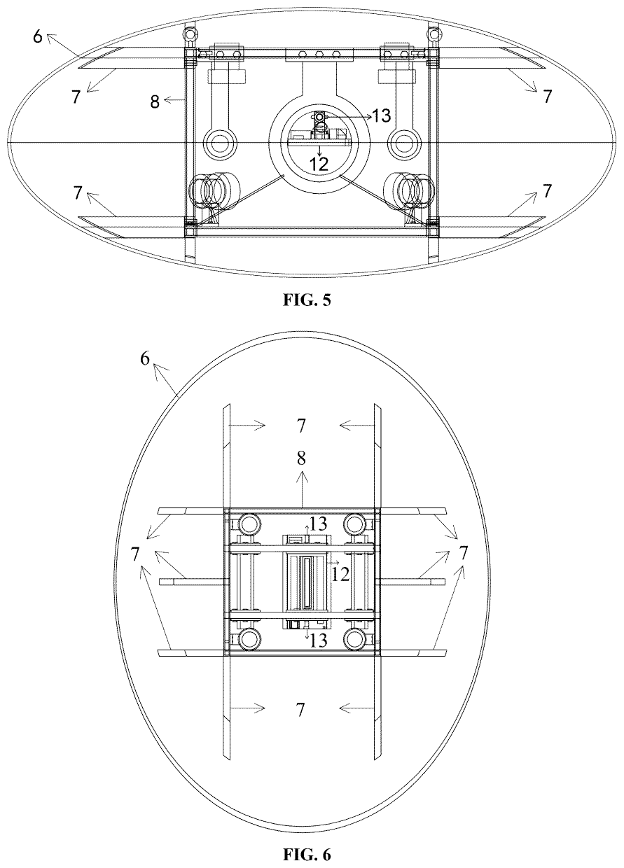

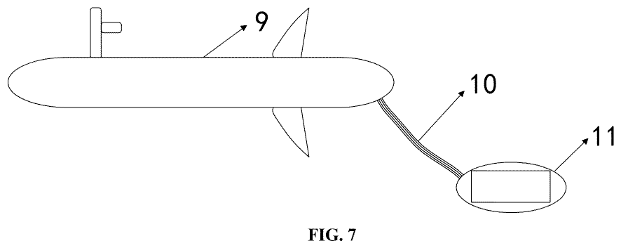

The overall structure of the underwater unmanned vehicle 11 is shown in FIGS. 4, 5 and 6, where the outer frame of the underwater unmanned vehicle 6 is of a crab-like shape design as shown in the figures. A fixing device 7 is configured to connect the underwater unmanned vehicle frame 8 and the outer frame of the underwater unmanned vehicle 6. The fixing device 7 includes eight cylindrical members, each with an inclined plane at one end thereof. The eight cylindrical members are respectively fixed to eight external corners of the underwater unmanned vehicle frame 8. Eight smooth ends of the eight cylindrical members are respectively connected to the eight external corners of the underwater unmanned vehicle frame 8 by screws, and the opposite eight ends of the eight cylindrical members with the inclined plane are connected to the outer frame of the underwater unmanned vehicle 6 by screws, thereby fixing the underwater unmanned vehicle frame 8 within the outer frame of the underwater unmanned vehicle 6. FIG. 7 shows a schematic diagram of cooperation between an unmanned surface vessel 9 and the underwater unmanned vehicle 11. The unmanned surface vessel is denoted with reference numeral 9. A tow rope is denoted with reference numeral 10 and designed for the cooperation between the unmanned surface vessel 9 and the underwater unmanned vehicle 11, and the tow rope has the functions of carrying the towing weight of the underwater unmanned vehicle 11, supplying power to the underwater unmanned vehicle 11, and communicating with the underwater unmanned vehicle 11. The underwater unmanned vehicle is denoted with reference numeral 11, the unmanned surface vessel 9 is connected with the underwater unmanned vehicle 11 by the tow rope 10.

When the underwater unmanned vehicle is not required to work, the underwater unmanned vehicle, based on the crab-like shape design, reduces the resistance and achieves the passive self-balance during the towing process of the unmanned surface vessel 9. The four robotic arms are controlled to imitate a movement of limbs of dogs in water to assist the underwater unmanned vehicle 11 to achieve the passive balance during towing.

When there is a work demand for the underwater unmanned vehicle 11, the buoyancy regulation module 2 regulates buoyancy by increasing or decreasing the air inside the vacuum cylinders, and the master control module 12 controls the eight propellers in the propulsion module according to the current status of the underwater unmanned vehicle 11, achieving balanced movement in all directions such as up, down, left, right, forward, and backward and thereby meeting the active motion requirements for underwater operations. Additionally, the master control module 12 is capable of controlling the four robotic arms in the underwater unmanned vehicle execution module to imitate the movement of limbs of dogs in water, assisting the underwater unmanned vehicle 11 in active motion, thereby achieving active motion balance during underwater operations.

The foregoing descriptions are merely preferred embodiments of the present disclosure, but are not intended to limit the present disclosure. Any modification, equivalent replacement, or improvement made without departing from the spirit and principle of the present disclosure shall fall within the protection scope of the present disclosure.

What is claimed is:

1. A bionic multi-armed underwater unmanned vehicle for underwater operations of an unmanned surface vessel, being towed by the unmanned surface vessel through a tow rope for realizing communications and power supply, comprising a master control module, a buoyancy regulation module, a propulsion module, an underwater unmanned vehicle execution module and a sensing module, which are located within a underwater unmanned vehicle frame, wherein the underwater unmanned vehicle frame is connected to an outer frame of the underwater unmanned vehicle through fixing devices; the outer frame of the underwater unmanned vehicle is of a crab-like shape design, a passive balance of the underwater unmanned vehicle is achieved during towing of the unmanned surface vessel when the underwater unmanned vehicle is not required to work; when there is a work demand for the underwater unmanned vehicle, underwater operators are replaced by the underwater unmanned vehicle to carry out underwater operations; and by means of the power supply and communications transmitted by the tow rope of the unmanned surface vessel, power propulsion of the propulsion module, buoyancy regulation of the buoyancy regulation module, and control of the master control module, the underwater unmanned vehicle is capable of achieving an active balance of movement; and a sensor module is configured for acquiring underwater images, and the underwater unmanned vehicle execution module comprised of robotic arms is configured for carrying out underwater operations.

2. The bionic multi-armed underwater unmanned vehicle for underwater operations of an unmanned surface vessel according to claim 1, wherein the master control module and the sensing module are arranged in a cylindrical watertight compartment which is disposed in a center of the underwater unmanned vehicle frame.

3. The bionic multi-armed underwater unmanned vehicle for underwater operations of an unmanned surface vessel according to claim 2, wherein the propulsion module comprises eight underwater propellers, and the eight propellers are divided into two configurations, each of the two configurations with four propellers; in one configuration, four propellers are respectively arranged at four corners of an upper part of the underwater unmanned vehicle frame, with a direction perpendicular to a horizontal plane, providing power for the underwater unmanned vehicle to move up and down; in an other configuration, four propellers are respectively arranged at four corners of a lower part of the underwater unmanned vehicle frame, with two propellers arranged in a front and the other two propellers arranged in a rear; and an overall direction of the four propellers in the other configuration is parallel to a water surface, and the two propellers in the front are positioned at an angle of 45° relative to each other and the other two propellers in the rear are positioned at the angle of 45° relative to each other, providing power for the underwater unmanned vehicle to move forward, backward, left and right.

4. The bionic multi-armed underwater unmanned vehicle for underwater operations of an unmanned surface vessel according to claim 3, wherein the underwater unmanned vehicle execution module comprises four robotic arms respectively disposed at the four corners of the upper part of the underwater unmanned vehicle frame.

5. The bionic multi-armed underwater unmanned vehicle for underwater operations of an unmanned surface vessel according to claim 4, wherein when the underwater unmanned vehicle is not required to work, the underwater unmanned vehicle, based on a crab-like shape design, reduces a resistance and achieves a passive self-balance during towing of the unmanned surface vessel; and the four robotic arms are controlled to imitate a movement of limbs of dogs in water to assist the underwater unmanned vehicle to achieve the passive self-balance during the towing.

6. The bionic multi-armed underwater unmanned vehicle for underwater operations of an unmanned surface vessel according to claim 5, wherein the buoyancy regulation module comprises two vacuum cylinders respectively disposed on a left of the cylindrical watertight compartment and a right of the cylindrical watertight compartment, with a center axis of each of the two vacuum cylinders parallel to a center axis of the cylindrical watertight compartment.

7. The bionic multi-armed underwater unmanned vehicle for underwater operations of an unmanned surface vessel according to claim 6, wherein when there is a work demand for the underwater unmanned vehicle, the buoyancy regulation module regulates a buoyancy by increasing or decreasing an air inside the vacuum cylinders, and the master control module controls the eight propellers in the propulsion module according to a current status of the underwater unmanned vehicle, achieving a balanced movement in all directions such as up, down, left, right, forward, and backward and thereby meeting an active movement requirements for underwater operations; and the master control module is capable of controlling the four robotic arms in the underwater unmanned vehicle execution module to imitate the movement of limbs of dogs in water, assisting the underwater unmanned vehicle in active motion, thereby achieving active motion balance during underwater operations.

8. The bionic multi-armed underwater unmanned vehicle for underwater operations of an unmanned surface vessel according to claim 1, wherein the fixing device comprises eight cylindrical members, each with an inclined plane at one end thereof, and the eight cylindrical members are respectively fixed to eight external corners of the underwater unmanned vehicle frame; eight smooth ends of the eight cylindrical members are respectively connected to the eight external corners of the underwater unmanned vehicle frame by screws, and opposite eight ends of the eight cylindrical members with the inclined plane are connected to the outer frame of the underwater unmanned vehicle by screws, thereby fixing the underwater unmanned vehicle frame within the outer frame of the underwater unmanned vehicle.

9. The bionic multi-armed underwater unmanned vehicle for underwater operations of an unmanned surface vessel according to claim 6, wherein the cylindrical watertight compartment and the buoyancy regulation module are respectively connected to the underwater unmanned vehicle frame through fixing connection devices; and each of the fixing connection devices has an upper part with a pan-like shape, and a portion, with a pan-handle-like shape, of the upper part is fixed to the upper part of the underwater unmanned vehicle frame by screw bolts, and each of the fixing connection devices has a lower part which is fastened to the lower part of the underwater unmanned vehicle frame by a tightened steel wire rope.
